(19) United States
(12) Patent Application Publication
(10) Pub. No.: US 2008/0265020 A1
(43) Pub. Date: Oct. 30, 2008

(54) System and method for performing payment transactions, verifying age, verifying identity, and managing taxes

(75) Inventors: Sean Copeland, Delta (CA); Csaba Fekszi, Budapest (HU); Zalan Lorand Szilagyi, Budapest (HU)

Correspondence Address: KING & SPALDING LLP, 1180 PEACHTREE STREET, ATLANTA, GA, 30309-3521, US

(73) Assignee: Business Intelligent Processing Systems PLC

(21) Appl. No.: 12/069,564

(22) Filed: Feb. 11, 2008

Related U.S. Application Data
(60) Provisional application No. 60/900,563, filed on Feb. 9, 2007.

(51) Int. Cl. G06K 5/00

(52) U.S. Cl. 235/380

(57) ABSTRACT

Age authentication and management of taxes for a merchant. The merchant can verify the age of a customer based on the customer's use of a smartcard that is obtained from a validation authority. The smartcard may contain a certificate related to the age of the user. By utilizing the smartcard, the user can go to an online, virtual, or brick-and-mortar merchant and buy goods requiring age restrictions. When the customer proceeds to purchase a good or service requiring age verification, the merchant's application can obtain information from the smartcard and request from the validation authority information authenticating the user's age. Further, the validation authority may also remit and pay taxes on behalf of the merchant based on the location of the merchant and other information stored in a merchant profile.

### PRIORITY APPLICATION

The present invention claims priority to U.S. Provisional Patent Application No. 60/900,563, filed on Feb. 9, 2007, the complete disclosure of which is hereby incorporated herein by reference.

### TECHNICAL FIELD

The present invention is generally directed to performing payment transactions, and, in particular, the invention is useful for verifying age and identity, and collecting and remitting taxes revolving around payment transactions.

### BACKGROUND OF THE INVENTION

Conventional online, virtual, and merchant payment transactions may be performed through a variety of payment sources, including credit, check, and stored value cards. In some cases, credit or check cards may be combined with a smartcard. A smartcard is typically a pocket-sized card embedded with integrated circuits, through which information may be stored and, in some cases, processed. To use a smartcard, a user may swipe or wave the smartcard in front of a smartcard reader, in turn providing information to the smartcard reader concerning the payment source (e.g., credit card account; debit card account; prepaid card account) affiliated with the smartcard.

Despite the availability of smartcards as a payment source, they still have limitations. One of these limitations is the inability of a merchant to verify the user's identity and age through the smartcard. Furthermore, conventional smartcards do not give a user and merchant a method for conveniently managing taxes. Accordingly, there presently exists a need in the art for an inventive system and method that can provide access to multiple accounts using a smartcard, verify the identity and age of a user using a smartcard, while also providing a convenient method for collecting and remitting taxes to a governmental taxation authority.

### SUMMARY OF THE INVENTION

The present invention solves the aforementioned problems associated with conventional technologies by providing access to multiple accounts through the use of a smartcard, verifying the identity and age of a smartcard user without resorting to other forms of identity during a payment transaction, and simplifying tax collection and remittance for merchants and users.

In a representative operating environment, a user obtains a smartcard from a validation authority. The validation authority may take many forms, but in an exemplary embodiment, the validation authority is a physical place where a user may present forms of identification to an attendant, who then issues a smartcard that may be used with the present invention. Accordingly, once the user has obtained a smartcard from the validation authority, the user (i.e., client) may then proceed to use the smartcard to purchase goods and/or services from an online, virtual, or brick-and-mortar merchant.

If the user chooses to purchase a product and/or service at a retail outlet location (i.e., brick-and-mortar merchant), the smartcard may be inserted into, placed in or positioned proximate to for communication with a smartcard enabled point-of-sale terminal. The user may then choose which linked personal account to pay from and authorize a payment request to the validation authority. The validation authority may determine if the products or services being purchased are age appropriate for the user based on the “age of use” data (i.e., the birth date or some other info identifying the age of the user) stored on the smartcard. When the age of the use data indicates that the user is below the appropriate age level, for example, the legal age limit, the merchant will be notified and the transaction will not be able to continue. However, if the age of use data indicates the user is above the legal age, the transaction continues, and the point-of-sale device will communicate the appropriate tax information to the validation authority. The validation authority may then validate the availability of funds, initiate a transfer of the funds, and signal an approval to the point of sale device. The validation authority may also retain or collect funds from the merchant for the remittance of taxes on behalf of the merchant. For example, the validation authority may automatically withdraw funds from an account maintained by the merchant when a transaction is processed using the present invention.

### BRIEF DESCRIPTION OF THE DRAWINGS

FIG. 1 illustrates a functional block diagram of an operating environment for an an exemplary embodiment of the present invention.

FIGS. 2A and 2B illustrate methods for signing up for a smartcard, according to certain exemplary embodiments of the present invention.

FIG. 3 illustrates a method for setting up accounts with a smartcard, according to an exemplary embodiment of the present invention.

FIG. 4 illustrates a method of signing up, creating an identity, and validating the age of a consumer according to an exemplary embodiment of the present invention.

FIG. 5 illustrates a physical device and a digital identity of a user according to an exemplary embodiment of the present invention.

FIG. 6 illustrates a method of validating age during a payment transaction, according to an exemplary embodiment of the present invention.

FIG. 7 illustrates a method of payment initiated by user at a brick-and-mortar merchant, according to an exemplary embodiment of the present invention.

FIG. 8 illustrates a method of payment initiated by a user in an online or virtual environment, according to an exemplary embodiment of the present invention.

FIG. 9 illustrates a method of taxation calculation and collection, according to an exemplary embodiment of the present invention.

### DETAILED DESCRIPTION OF THE EXEMPLARY EMBODIMENTS

The present invention allows an individual or entity to purchase goods and/or services online, offline, or in a virtual environment. Further, the present invention is capable of verifying the age of an individual to reduce the possibility of minors accessing goods or services for which they should not have access. The present invention also allows taxes to be calculated and deducted on behalf of a taxation authority as directed by a merchant and/or user. In doing so, the present invention can provide for the automated submission of taxation payments from the point of sale terminal directly to the relevant taxation authority.

The present invention can be used in at least three different operating environments: a physical brick-and-mortar environment; an online environment; and a virtual environment, such as in a gaming world. The present invention can provide age and identity information for all three environments. Moreover, because the age and identity of the user has been physically confirmed at the issuance of the smartcard, the chance of fraud (and the associated costs of fraud) are reduced.

The present invention can support operations for multiple accounts held by a user or customer. For example, multiple credit accounts or checking accounts may be stored on the smartcard or at the validation authority. The present invention also can automatically calculate and submit taxes on behalf of merchants and consumers utilizing the system, thereby reducing cost and effort on the part of the merchant to remain in compliance with local, state, provincial, and national tax regulations.

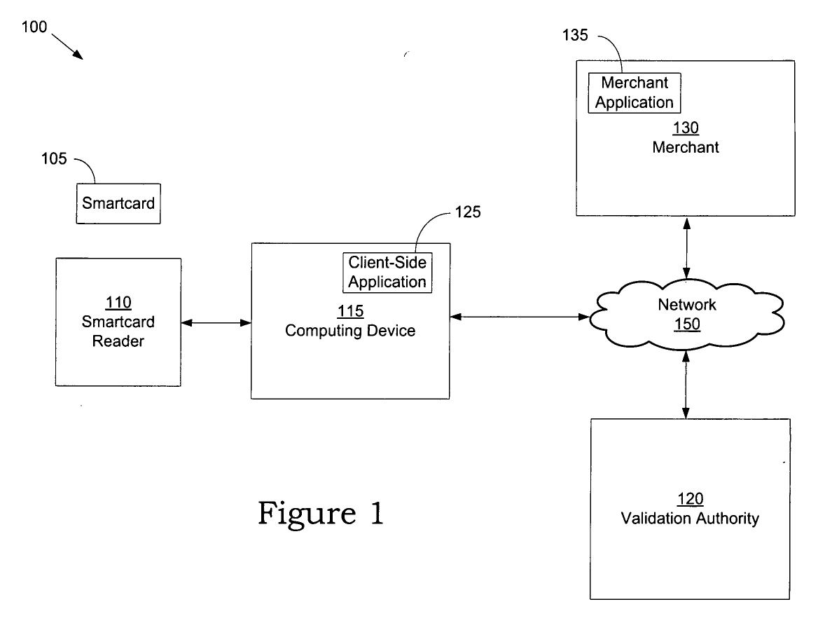

Turning to the several figures, in which like reference numerals represent like elements, FIG. 1 illustrates a representative operating environment 100 according to an exemplary embodiment of the present invention. As illustrated, an exemplary operating environment 100 may comprise a smartcard 105, a smartcard reader 110, a computing device 115, a validation authority 120, a network 150, and a merchant 130. A smartcard 105 typically comprises a card embedded with integrated circuits. The smartcard may be capable of storing data, such as personal data, and may be capable of functionally interacting with the smartcard reader 110 to provide access to the information stored on the smartcard 105. It is noted that the smartcard reader 110 may be a stand-alone card reader (i.e., one that can be utilized at a user's place of business or home) or may be integrated into a point-of-sale device for use at a physical location of a merchant 130. In either case, according to an exemplary embodiment, the smartcard 105 may be inserted and/or otherwise communicably connected to the smartcard reader 110 to provide information stored on the smartcard 105.

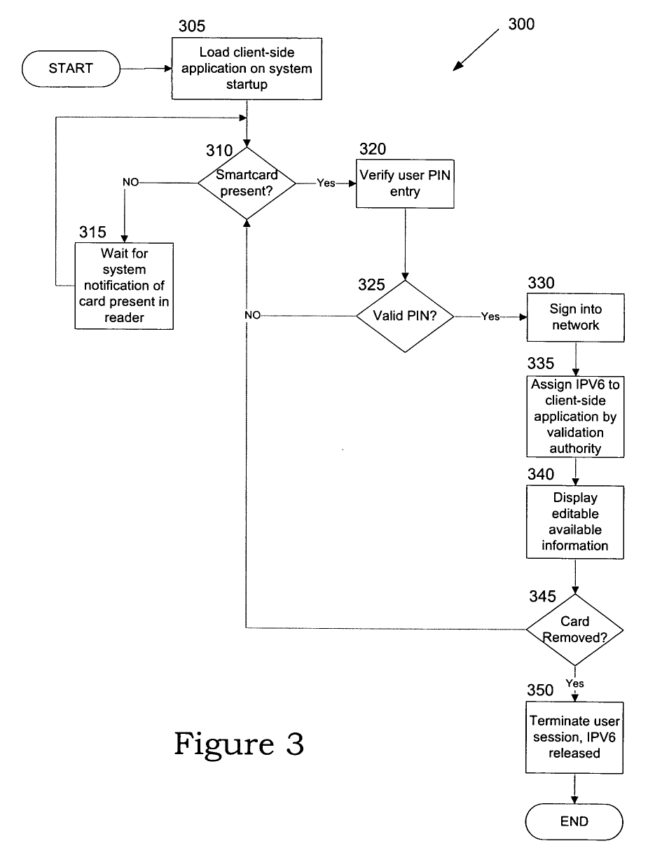

In an exemplary embodiment, the smartcard reader 110 is communicably connected to the computing device 115. In this way, the computing device 115 and the smartcard reader 110 may exchange information and commands. Further, as illustrated in FIG. 3, the computing device 115 may also be connected to the validation authority 120 and the merchant 130 through a network 150, according to an exemplary operating environment of the present invention. Using the network 150, which may comprise any medium (e.g., Internet) that allows secure information to flow between the parties, the merchant 130, validation authority 120, and computing device 115 may pass information to one another.

The computing device 115 and the merchant 130 may exchange information by utilizing applications running on each system. To perform this task, according to an exemplary embodiment, the computing device comprises a client-side application 125 and the merchant 130 comprises a merchant application 135. These applications may take the form of any software application running some or all of the methods recited herein, and the applications may comprise third-party plug-ins or other types of downloadable execution files running on the computing devices at the client and merchant 130 locations.

According to an exemplary embodiment, the validation authority 120 may comprise a third-party through which a smartcard 105 (containing a certificate confirming the age and identity of a user) and/or smartcard reader 110 may be provided to a user (i.e., client) and verified during a payment transaction. Further, in an alternative embodiment, the validation authority 120 may comprise a third-party that validates the age and identity of the user by accessing one or more certificate stored on the smartcard, but does not supply the smartcard 105 (including certificates), smartcard readers 110, and/or other applications to the user and/or merchant. Further, the validation authority 120 may additionally or alternatively comprise one or more entities working in unison to accomplish the processes carried out by the present invention.

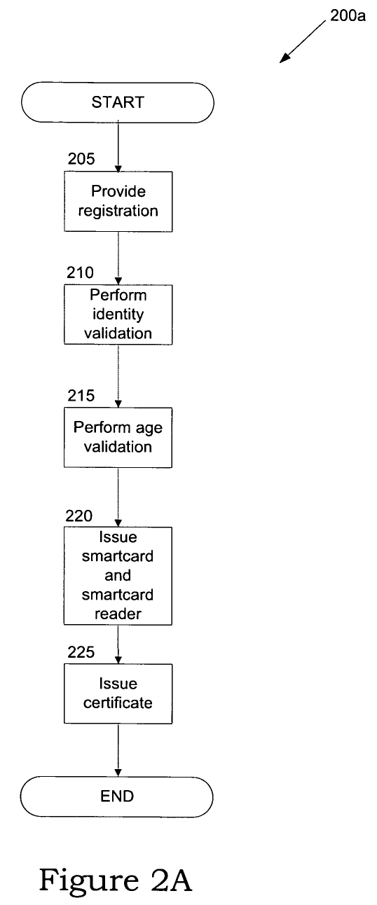

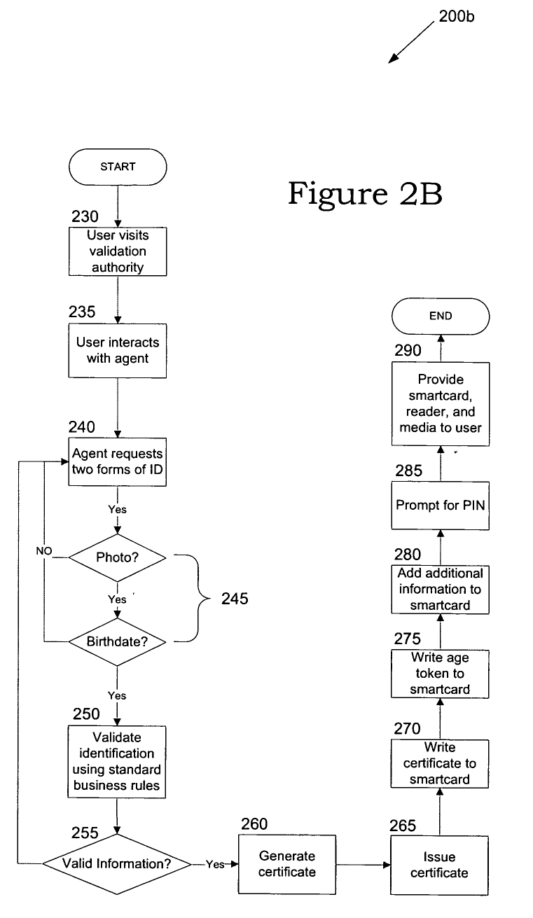

FIGS. 2A and 2B illustrate methods for assigning a smartcard 105 to a user, according to certain exemplary embodiments of the present invention. As illustrated in FIG. 2A, at step 205 a validation authority 120 may provide a user an ability to register for a smartcard 105 to be used with the inventive system and method. In particular, a user may visit a physical location where a validation authority 120 resides. This validation authority 120 may be a business dedicated solely to activities related to the smartcards 105 or may be part of another business. In either case, the user may request to sign-up to use for a smartcard 105 and/or smartcard reader 110 at the validation authority 120.

Following a request by a user, at step 210, an identity validation is performed at the validation authority 120. In an exemplary embodiment, an identity validation occurs by checking a form of picture identification to verify the identity of the user. Then, at step 215, the age of the user may be further validated. For example, a government identification may be required to verify that the user is over a certain age (e.g., 18).

After the user's age and identity have been validated, the validation authority 120 may issue a smartcard 105 at step 220. The smartcard 105 may comprise information pertaining to the identity and the age of the user. Further, in addition or in the alternative, the validation authority 120 may also provide a smartcard reader 110 to the user. By so doing, the user can utilize the smartcard 105 to make purchases and verify age at business or home by connecting the card reader 110 to a computing device 115.

Finally, once the user has received a smartcard 105 and smartcard reader 110, the validation authority 120 may store (i.e., issue to the user) a certificate on the smartcard 105 at step 225. The certificate is provided to the user in order to verify the age and identity of the user. A certificate used to verify the identity of a user may comprise a Public Key Infrastructure (PKI), which may be used by the validation authority 120 to ensure that the smartcard 105 data is authentic. Further, the smartcard 105 may be provided an age token to verify the age of the user. This may be done through an extension of the standard PKI. In particular, the PKI may be extended by registering an Object Identifier (OID) for specific use so it appears in the OID Repository. This creates a field/value combination, with the field being fixed, e.g., “CNAME,” and the value being any value for that field, e.g., “Sean.” Thus, by registering the OID, additional data fields can be added to the existing structure of the age token (i.e., the certificate).

In addition to the exemplary method illustrated in FIG. 2A, FIG. 2B illustrates an alternative exemplary method for providing a user a smartcard 105. At step 230, the user may go to a validation authority 120 to receive a smartcard 105 according to the present invention. Once there, the user may interact with an agent, at step 235, to request a smartcard 105. The agent, at step 240, may request two pieces of identification (“ID”) to validate the identity and age of the user. Accordingly, at step 245, the agent verifies the identity and age of the user by physically examining the forms of ID. If the identity and age cannot be verified, however, the agent may again request two forms of identification at step 240. As illustrated by step 250, the age and identity of the user may be validated using standard business rules. Thus, if the rules require that a smartcard 105 be issued only to those persons 18 years of age and older, then, in step 250, these business rules are consulted and followed prior to continuing the process.

If the user satisfies the validation and age requirements, and the information is valid at step 255, then a certificate is generated by the validation authority 120 at step 260. The certificate guarantees the user's identity, and can be used with the smartcard 105 in a brick-and-mortar, online, or virtual environment. Further, as noted, the certificate may comprise a PKI stored on the smartcard 105 that can be used by the validation authority 120 to ensure the authenticity of the smartcard 105 and its user. Accordingly, in steps 265 and 270, the certificate may be issued and written to the smartcard 105. Further, at step 275, an extension to the PKI comprising an age token may be written to the smartcard 105, along with the identity certificate. The age token may then be used to verify the age of a user in an online, virtual, or brick-and-mortar environment. For instance, the age token may confirm that the user is over a certain age, thus allowing the user to purchase goods and/or services requiring the purchaser to be “over 18,” for example.

After the certificate and age token are written to the card 105, the validation authority 120 may write any additional information to the smartcard 105 at step 280. For example, a user may wish to record their social security number on the smartcard 105 to provide further validation when they perform transactions using the smartcard 105. Following this step (which may or may not be performed), at step 285 the validation authority 120 may provide the user an opportunity to supply a personal identification number (“PIN”) to be used with the smartcard 105. For instance, an agent of the validation authority 120 may request that the user supply a PIN for the smartcard 105. By providing a PIN, the user can help ensure that the smartcard 105 will not be utilized by an unauthorized person. Accordingly, once the user supplies a PIN, the agent provides the smartcard 105 containing the certificate, age token, and other information to the user at step 290. Further, in addition to the smartcard 105, the agent of the validation authority 120 may also provide the user with a smartcard reader 110 and media for installing and using the smartcard reader 110 at the user's home and/or business. For example, the validation authority 120 may provide the user with a Universal Serial Bus memory device (e.g., flash drive), Compact Disc, or Digital Versatile Disc containing an executable file so that the user can install the smartcard reader 110 and/or client-side application 125 on his or her computing device. Alternatively, the user may download the program for the smartcard reader 110 and/or client-side application 125 from a website maintained by the validation authority 120 (or another third-party). In either case, once installed, the client-side application 125, computing device 115, and smartcard reader 110 will function together to read and use the smartcard 105 issued to the user.

Following the issuance of the smartcard 105 by the validation authority 120, the user may install the client-side application 125 on his or her computing device 115. The application 125 may allow the user to perform functions of the present invention, such as utilizing the smartcard 105 to validate age and identity. Accordingly, once the user has installed the client-side application 125, the user may proceed to utilize the smartcard 105 (and smartcard reader 110, if applicable) to perform transactions. FIG. 3 illustrates a method for validating a user and logging into the present invention, according to an exemplary embodiment. As illustrated, the process begins at step 305, where the user may initiate the client-side application 125 by selecting to run the software program or application. Once this occurs, the client-side application 125 loads and queries the smartcard reader 110 to verify that a smartcard 105 is present in the reader at step 310. If a smartcard 105 is not present, then at step 315 the application waits for a notification from the smartcard reader 110 that a smartcard 105 is present. At step 315, the application 125 may also notify the user that a smartcard 105 is not present by presenting a graphical presentation to the user utilizing a monitor (not shown) that can be attached or comprise a part of the computing device 115.

If a smartcard 105 is present at step 310, the process follows the “YES” path to step 320, where the application requests the user to enter his or her assigned PIN into the computing device to continue. This PIN may be the same PIN provided by the user at the validation authority 120, as discussed with reference to FIG. 2B. If the PIN entered is valid, as determined in step 325, the process continues to step 330, where the application signs onto the network 150. However, if the PIN is invalid, the application flows back to step 310, where the smartcard 105 is again verified and a prompt for a PIN to utilize the card is provided to the user.

When properly entered, the client-side application 125 in step 330 signs onto the network 150 to connect to the validation authority 120. In an exemplary embodiment, the application 125 securely connects to the network 150 by providing a password to access the validation authority 120 at step 330. However, in another exemplary embodiment, the validation authority 120 may connect without a password by using an encrypted connection. In either case, once the application 125 has connected to the validation authority 120, the validation authority 120 assigns the client-side application 125 a unique protocol identification. In an exemplary embodiment as shown in step 335, this unique identification comprises an Internet Protocol version 6 (IPV6); however, other unique identification, such as Internet Protocol version 4, may also be used without departing from the spirit and scope of the present invention. The IPV6 is a network layer for a packet-switched protocol, which allows for the interchange of information between two communication devices. In an exemplary embodiment, once the client-side application 125 is assigned an IPV6, it is then able to exchange information with the validation authority 120, thereby allowing the validation authority 120 to validate the age and identity of the user of the smartcard 105.

In step 340, once the application 125 is connected to the validation authority 120, access is provided to the user to edit information retained at the validation authority 120. This access may be provided through the client-side application 125 (via the computing device 115 interface), and, in certain exemplary embodiments, this editable information may include, but is not limited to, the user's name, phone number, and address. After information is (or is not) edited by the user, the editable fields may be sent back to the validation authority 120 by the application 125 using the network 150. Thus, when the user logs onto the system utilizing the client-side application 125 with the smartcard 105 in the smartcard reader 110, he or she may associate or link accounts with his or her smartcard 105 using the client-side application 125. In this way, the user may be able to utilize the linked accounts to process payments using the smartcard 105. To link the accounts, the user may enter bank account information or other information identifying an account that he or she would like to use for payment using the smartcard 105. The application 125 residing on the computing device 115 will then instruct the smartcard reader 110 to store the information for the linked accounts on the smartcard 105, thereby allowing the user to remove the smartcard 105 from the smartcard reader 110 and utilize the smartcard 105 at other locations, such as a brick-and-mortar merchant 130. Further, in an alternative or additional exemplary embodiment, the client-side application 125 may pass the information for the linked accounts to the validation authority 120 for storage at the validation authority 120.

Once the user's information is edited and stored for the smartcard 105, the process continues to step 345, where the application determines if the smartcard 105 is still present in the smartcard reader 110. If not, the process returns to step 310. If the card is present, however, the user session may be terminated at step 350. At this point, information exchanged between the application 125 and the validation authority 120 may be saved to the smartcard 105 using the smartcard reader 110. During this process, the network connection may be discontinued and the IPV6 assigned by the validation authority 120 may be released (i.e., the address may be released so that it can be assigned by the validation authority 120 to other users).

After the user has set up an account using the client-side application 125, he or she may perform a transaction with a merchant 130 utilizing the present invention. According to an exemplary embodiment, the user can visit an online merchant 130 and purchase goods or services by utilizing a “shopping cart” or similar checkout method maintained by the online merchant 130. In an exemplary embodiment, the merchant 130 will have a merchant application 135 through which a user may select to make a payment using the present invention. The merchant application 135 comprises a software program or application that may be utilized on a computing system or device at the merchant 130 to interact with the validation authority 120 and user computing device 115 over the network 150.

The merchant 130 may install the merchant application 135 in the same way that a user installs the client-side application 125 (e.g., by using medium from the validation authority 120 or through downloading an application from a website). Also, in an alternative embodiment, the validation authority 120 may provide the merchant 130 with equipment in which the merchant application 135 is pre-installed. Whatever the case, the merchant application 135 running at the merchant location or website may allow for communication with the client-side application 125, thus allowing for a user to initiate a three legged transaction between the computing device 115, the merchant 130, and the validation authority 120.

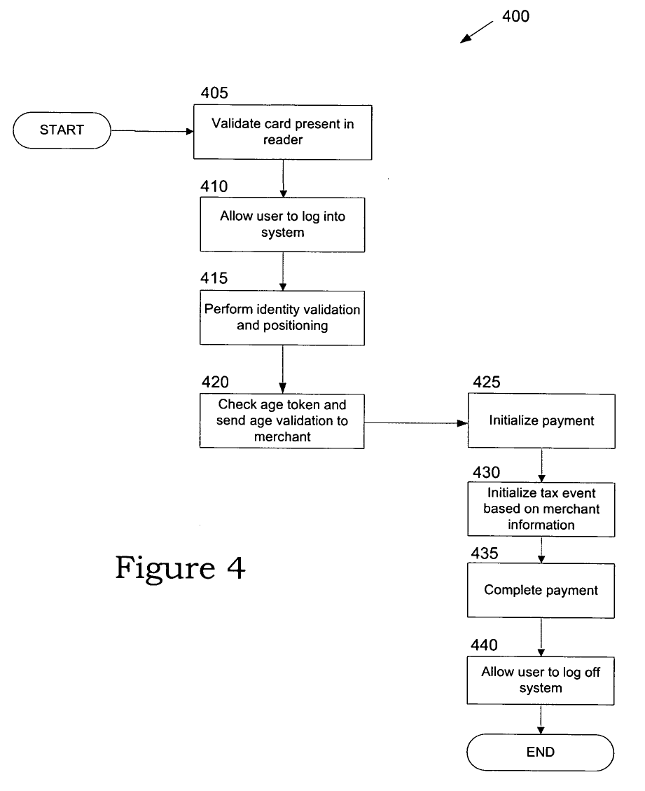

FIG. 4 illustrates a method for performing a transaction between a merchant 130 and user according to an exemplary embodiment of the present invention. As illustrated at step 405, the computing device 115 verifies that the smartcard 105 is connected to the card reader 110. This step may occur at a brick-and-mortar merchant location or in an online or virtual environment. In a brick-and-mortar setting, the smartcard 105 may be inserted into a point-of-sale terminal, and, in an online or virtual environment, the user may insert the smartcard 105 into the card reader 110 that may be provided by the validation authority 120. Regardless of the environment, once the computing device has verified that a smartcard 105 is in the smartcard reader 110 or point-of-sale terminal, the client-side application 125 may open to allow the user to log onto the system at step 410.

After opening, the client-side application 125 can request the user to enter a PIN to continue. After logging in using the PIN or other password, the client-side application 125 performs an identity validation and positioning based on the information stored on the smartcard 105 at step 415. The validation step comprises confirming the user at the validation authority 120 by, for example, checking that the certificate issued to the smartcard 105 has not been revoked for any reason. The second part of this process, positioning, involves performing a reverse query back to the computer the user is on to determine the geographic location of the user from the number assigned by the user's Internet Service Protocol. This may be done by ensuring that the IPV6 number (or other user identification) of the user matches the geographic location in which the validation authority 120 expects the smartcard 105 to be used. For example, if a smartcard 105 has been issued to someone in New York, yet the IPV6 number indicates to the validation authority 120 that the computer from which the smartcard 105 is being used is located in Hong Kong, then the validation authority 120 may recognize that there is an issue with the card and prohibit the transaction from occurring. This provides a measure of security for the user of the smartcard 105. Further, according to an exemplary embodiment, a user may be allowed to provide a pass-code or other identification to override this functionality when needed, such as when the user is traveling and would like to use the smartcard 105 to perform a transaction.

Once validation and positioning for the smartcard 105 have been checked, the user may perform a transaction with the merchant. For example, the user may select an item to purchase from the merchant and place it into an online or virtual “shopping cart.” Then, when the user wishes to proceed with the transaction, the exemplary process can continue to step 420, where age information on the smartcard 105 is provided to the merchant 130. For example, the age token may be provided to the merchant directly from the smartcard 105. Further, in one exemplary embodiment, the user may be prompted by the merchant for a PIN to verify the age information from the validation information. Thus, if so prompted, the user can enter the requested information (e.g., PIN), allowing the merchant application 135 to contact the validation authority 120 and validate the information received from the client-side application 125 and/or smartcard 105. In this way, the merchant 130 is able to verify the age of the user of the smartcard 105 regardless of the environment in which the purchase takes place. This is especially advantageous in an online or virtual environment, where conventionally the merchant 130 is unable to verify the age of the user.

With the age and identity verified using the present invention, the process may continue to step 425, wherein the payment is initialized using the smartcard 105. In an exemplary embodiment, a payment source stored on the smartcard 105 may be selected to perform the payment transaction. However, alternatively, a payment source stored at the validation authority 120 may be used. In this case, the payment source may be selected from a list provided by the validation authority 120. For example, the validation authority 120 may send a list of accounts to the client-side application 125, whereby the user may select one of the accounts to use to pay for the transaction. Thus, once an account has been selected by the user, the validation authority 120 can forward the payment information for the selected account to the merchant so that the payment can be completed.

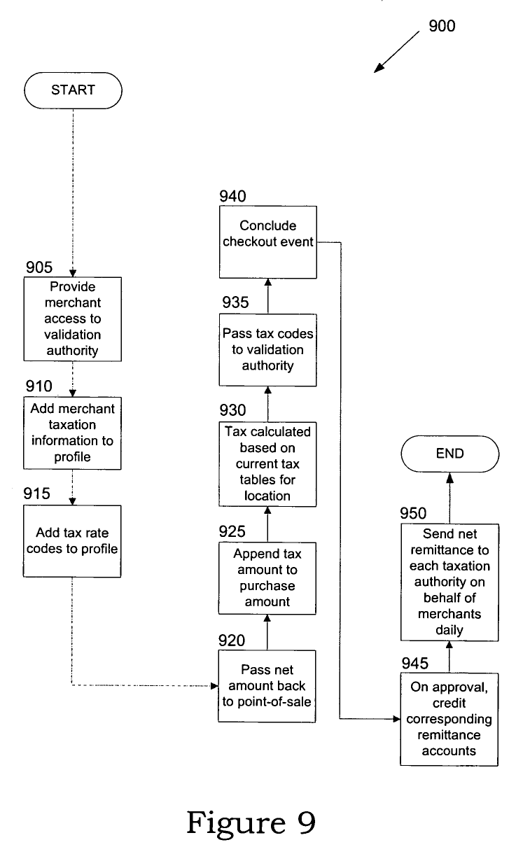

Furthermore, because the validation authority 120 receives information related to the transaction, it is able to calculate and deduct, at step 430, the taxes for the particular merchant 130 for which the payment transaction is being performed. In this way, the merchant 130 is relieved of the process of collecting and withholding taxes. As discussed in more detail with reference to FIG. 9, the validation authority 120 can base its tax calculations on the particular governmental regulations applicable to that particular merchant 130.

After taxes have been calculated for the merchant 130, the validation authority 120 may communicate with the client-side application 125 to display to the user the price of the payment transaction, including the allocated taxes for the transaction. At this point, the user may be asked to confirm the price in order to complete the payment transaction with the merchant 130. Hence, once the user has selected to complete the payment, a funds transfer is initiated between the linked personal accounts and the merchant's account to complete the payment transaction at step 435. Further, for tax remittance purposes, the validation authority 120 may remit the appropriate amount for taxes from the merchant 130 or the user's account at step 435. The user may then log off the system at 440.

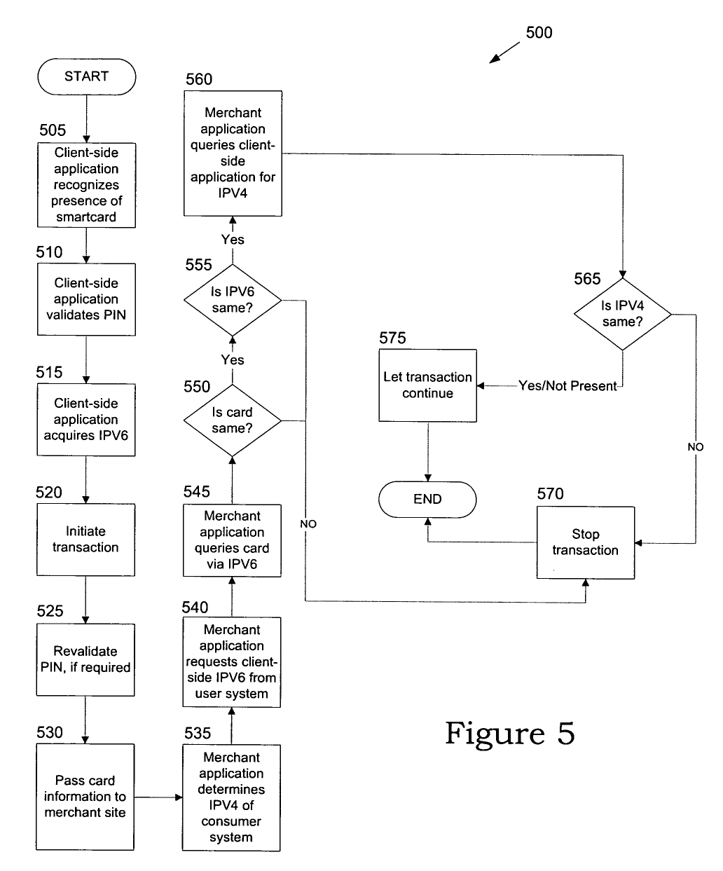

FIG. 5 illustrates another method for performing a payment transaction, according to an exemplary embodiment of the present invention. The process begins at the START step and continues to step 505, where the client-side application 125 verifies that the smartcard 105 is present in the smartcard reader 110. The process then proceeds to step 510, where the user is prompted by the client-side application 125 to enter a PIN. When the user enters his or her PIN associated with the smartcard 105, the PIN is validated by the client-side application 125 and the process continues to step 515, where the client-side application 125 acquires an IPV6 from the validation authority 120. As discussed with reference to FIG. 3, this may be performed in an exemplary embodiment by the application 125 connecting to the validation authority 120 over a network 150.

With the IPV6 acquired, a payment transaction may be processed utilizing the client-side application 125. In an exemplary embodiment, the user may simply connect to a merchant 130 using the Internet to perform the transaction. Once a good or service is selected (e.g., goods are placed in a shopping cart), the user may select to “check-out” of the online merchant 130. Because the application 125 is operating on the computing device, the merchant may recognize that the present invention can be used to perform the transaction. Accordingly, at step 525, a merchant application 135 running on a server or other computing device at the merchant 130 may ask the user to re-validate his or her PIN to perform the transaction using the smartcard 105.

If the user enters the appropriate PIN, according to an exemplary embodiment, the merchant application 135 requests for the client-side application 125 to pass the information related to the smartcard 105. This information may include certificates, age tokens, and accounts the user may use to pay for the transaction with. After the client-side application 125 passes along the requested information, the merchant application 135 must validate that the information it has received from the user is accurate. Therefore, at step 535, the merchant application 135 can determine the Internet Protocol Address, e.g., IPV4, of the connected system (i.e., the user's system). Then, at step 540, the merchant application 135 can contact the validation authority 120 and request the IPV6 that has been assigned to the client-side application 125 (see step 515).

With the IPV6 of the client-side application received, the merchant application 135 may then query the smartcard 105 at step 545. By doing so, at step 550, the merchant 130 is able to ensure that the smartcard 105 is the one that the client-side application 125 provided information for (i.e., does the card match the information initially received from the client-side application?). If not, the process stops at step 570. However, if the smartcard 105 matches, then, at step 555, the merchant application 135 can check to ensure that the IPV6 is the same as the one that the client-side application 125 previously received. As discussed, this may be done by querying the validation authority 120 for the IPV6 assigned to the client-side application. Following these steps, the merchant application 135 queries the client-side application for its IPV4 at step 560. Then, at step 565, the Internet Protocol Address of the user's system (acquired initially when the computing device connected to the merchant) is compared to the Internet Protocol Address provided by the client-side application 125. If the Internet Protocol Address is the same, then the merchant application 135 allows the process to continue. These above steps, therefore, ensure the authenticity of the information contained on the smartcard 105, while also verifying the authenticity of the information that the merchant 130 will receive from the validation authority 120. However, if the card, IPV6, or Internet Protocol Address are not the same in steps 550, 555 or 565, respectively, then the process is not authenticated and, therefore, proceeds to step 570, where the process is terminated. In contrast, however, if the information is authenticated, the process proceeds to step 575, where the payment transaction continues.

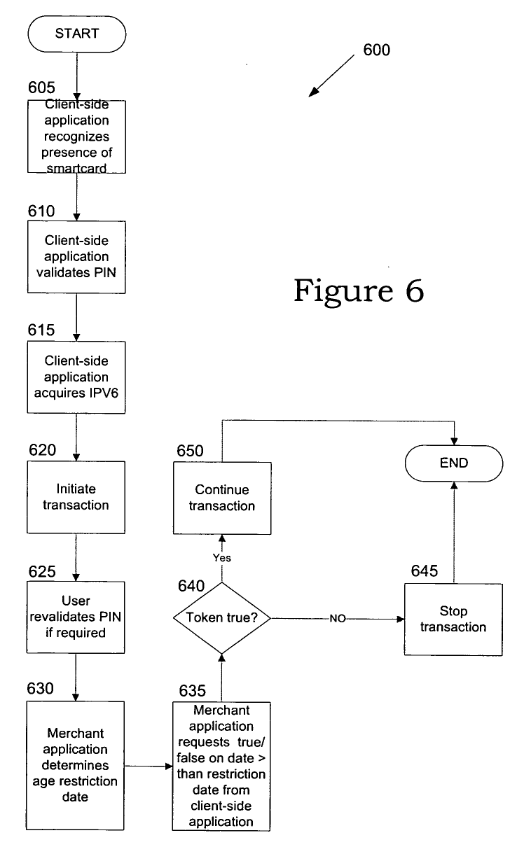

FIG. 6 illustrates a method of validating age during a payment transaction, according to an exemplary embodiment of the present invention. At step 605, the client-side application 125 recognizes that the smartcard 105 is present, thus enabling the operation of the present invention. At step 610, the user is required to validate his or her PIN to utilize the smartcard 105. Then, at step 615, the application 125 acquires an IPV6 for the client-side application 125 and smartcard 105. As discussed, this may occur by the application 125 connecting to the validation authority 120 in order to receive the IPV6. Continuing the process, a transaction is initiated in step 620. In an exemplary embodiment, the user may initiate the transaction by shopping at an online or virtual merchant 130. A virtual merchant 130 may comprise a seller of virtual goods in exchange for real currency.

After the user has initiated the transaction, a merchant application 135 at the merchant 130 may seek to validate the user again at step 625 by requesting the user to enter his or her PIN associated with the smartcard 105. Following this action, the merchant application 135 may determine if there are any age restrictions associated with the goods or services being purchased by the user at step 630. Then, by querying the smartcard 105 through the client-side application 125, the merchant application 135 may request, at step 635, whether the age of the user is greater than the required age for purchasing the goods and/or services. This query may be posed by asking whether the birth date of the user contained on the smartcard 105 occurred before a specified date provided by the merchant application 135. If the birth date stored on the smartcard 105 is prior to the date, then a “true” token may be returned to the merchant application 135. If the token is true at step 640, then the process continues to step 650, where it is allowed to complete. However, if the token that is returned to the merchant application 135 is “false,” then the transaction is terminated at step 645. This would be the case because the user is not authorized to purchase the goods or services, as indicated by the age token data stored on the smartcard 105. In addition or in the alternative, the merchant application 135 may receive an age token from the validation authority 120 to confirm the age of the user. For example, the merchant application 135 may contact the validation authority 120 to confirm the information received from the client-side application 125.

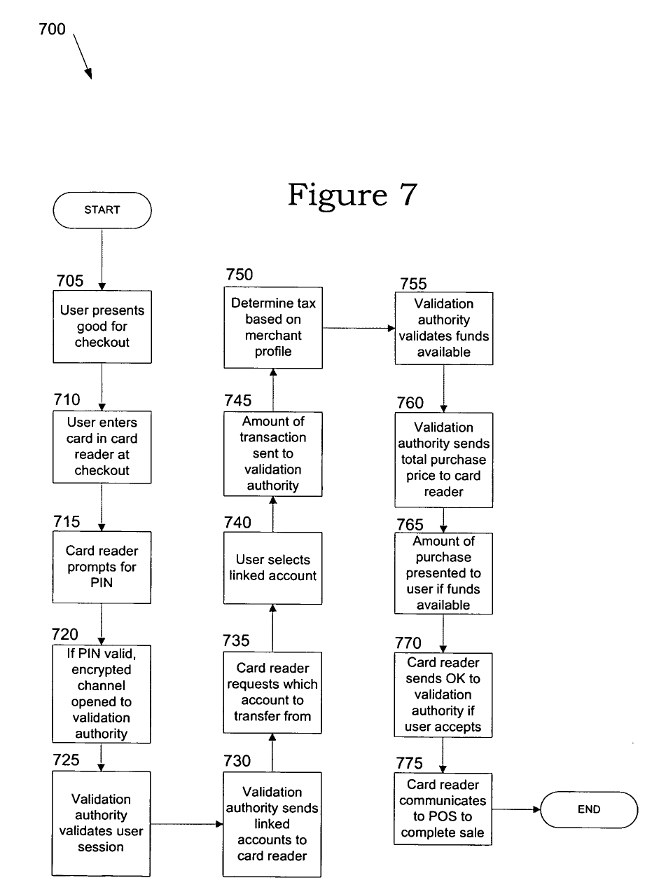

In addition to performing a transaction online or in a virtual environment, a user may also use the smartcard 105 to perform a traditional transaction using a point-of-sale terminal, which may comprise or have a card reader 110 communicably attached to it. FIG. 7 illustrates a method for performing a transaction according to an exemplary embodiment of the present invention. At step 705, the user present goods for checkout at a brick-and-mortar location. This checkout may comprise a self-checkout kiosk or a traditional checkout with a cashier. At step 710, the user enters (or swipes) the smartcard 105 at the checkout. In an exemplary embodiment, the point-of-sale terminal has been enabled to operate with the present invention (i.e., the point-of-sale terminal is able to communicate with or comprises the merchant application 135 so that information may be exchanged with the validation authority 120 and client-side application 120 over the network 150). Once the smartcard 105 is inserted, at step 715 the card reader 110 (e.g., point-of-sale terminal) can prompt the user to enter his or her PIN to verify the validity of the user.

After the user has entered his or her PIN, the card reader 110 can open an encrypted channel to the validation authority 120 at step 720. This encrypted channel may be opened over the network 150. Through the encrypted channel, the validation authority 120 is then able to validate the user session at step 725. For example, the validation authority 120 may send information to the card reader providing the age and identity of the user. Further, at step 730, the validation authority 120 may send the user's one or more linked accounts to the card reader 110. Then, at step 735, the point-of-sale terminal may request that the user select an account to process the transaction. This user's account information, identity, and age information may be stored and retrieved by the point-of-sale terminal from the smartcard 105 or from the validation authority 120. Whatever the case, however, the user may be presented a selection of payment accounts to choose from for the transaction and, at step 740, in response to the user selection, the user's account information can be passed from the validation authority 120 to the merchant 130.

As discussed, the validation authority 120 may manage taxes for the user and/or merchant 130. To calculate the tax attributable to the specific transaction, the validation authority 120 can receive, at step 745, the amount of the payment transaction from the merchant 130 (via the point-of-sale terminal or merchant application 135). With this information, the validation authority 120 can calculate the applicable tax for the transaction, based on any governmental or other applicable regulations, at step 750. For example, the validation authority 120 may have a record of all taxes applicable for each merchant 130 who uses the merchant application 135 (as discussed with reference to FIG. 9). Following this step, the validation authority 120 validates that funds are available to perform the transaction at step 755, and, if they are available, the validation authority 120 sends the total purchase price to the point-of-sale terminal at step 760. The point-of-sale terminal, in turn, presents the total amount of the purchase price at step 765 (i.e., including tax). If the user accepts the total amount, then the transaction is accepted and the point-of-sale terminal sends the authorization back to the validation authority 120 at step 770. The card reader then communicates to the merchant 130 (if the two are separate) the information to complete the transaction at step 775. For example, the smartcard reader 110 may transmit the linked account selected by the user to the merchant 130 (or point-of-sale terminal) so that the appropriate funds for the transaction can be withdrawn by the merchant 130. At the same time, the validation authority 120 may also remit the taxes necessary to cover the transaction from the selected user account or the merchant account.

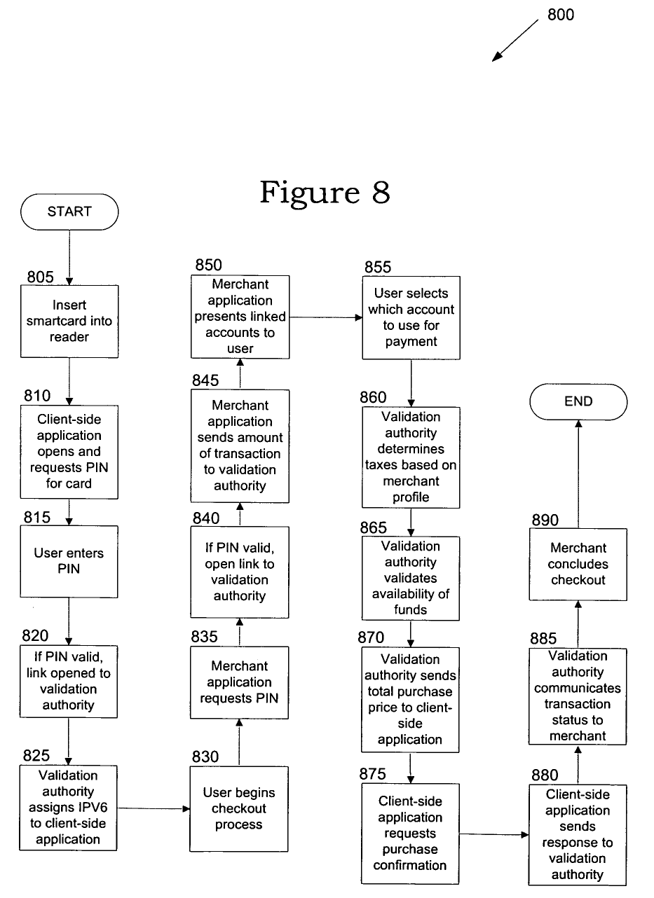

FIG. 8 illustrates a method for processing a payment transaction in an online or virtual environment, according to an exemplary embodiment of the present invention. If a user is purchasing a product or service in a virtual environment, the process is the same as an online environment, except the linked personal account being accessed may be one that exists in the virtual world and a virtual system application may take the place of the merchant application 135 (i.e., an application associated with the virtual world processes the transaction and communicates with the client-side application and smartcard 105). Thus, whether in an online or virtual environment, at step 805 the user inserts the smartcard 105 into the smartcard reader 110. In an exemplary embodiment the smartcard 105 and the reader 110 are provided to the user by the validation authority 120. At step 810, the client-side application 125 opens when the smartcard 105 is inserted. The application 125 then requests (through the computing device 115) that the user enter his or her PIN to utilize the smartcard 105 to perform a transaction at step 810. The PIN is entered at step 815 and, if valid, the process continues to step 820, where the client application 125 opens an encrypted link to the validation authority 120. The validation authority 120 then assigns an IPV6 to the client-side application at step 825.

At this point, the user is able to go online or into a virtual environment to perform a transaction. For example, the user can then visit a merchant 130 (online or virtual) and select a good or product to purchase. In this case, the user begins the checkout process, at step 830, and the merchant application 135 residing at the merchant 130 communicates with the client-side application 125 and requests a PIN from the user at step 835. If the PIN is valid, then the merchant application 135 opens a link to the validation authority 120 at step 840. This link may be encrypted to protect information exchanged between the systems.

At step 845, the amount of the transaction is sent from the merchant application 135 to the validation authority 120. The merchant application 135 in return receives a list of the user's linked accounts, which are presented to the user at step 850. From the list, the user selects an account at step 855. With the account selected and the transaction initiated, the validation authority 120 then calculates, at step 860, the amount of tax to apply to the transaction based on a profile maintained at the validation authority 120 for the merchant 130. This profile may contain the tax codes that are applicable to the specific merchant 130.

The validation authority 120 checks the selected account and verifies that it contains funds sufficient to cover the transaction at step 865. If so, the payment authority sends the total purchase price (with applicable tax calculated) to the client-side application at step 870. The client-side application then asks the user to authorize the purchase at step 875. Whatever the response, the client-side application sends it to the validation authority 120 at step 880 and the validation authority 120 communicates the transaction status to the merchant application 135 at step 885. Accordingly, if the transaction is accepted by the user, the process continues to step 890 where the selected account is passed to the merchant 130 for processing. At step 890, the point-of-sale terminal may produce a printed receipt for the user, along with a printed receipt for the merchant 130 including relevant taxation submission information calculated by the taxation process (as discussed in further detail below with reference to FIG. 9).

To perform the taxation process, in an exemplary embodiment, a merchant 130 may possess a profile with the validation authority 120 so that applicable taxes may be calculated for the merchant 130 for each payment transaction. FIG. 9 illustrates a method for establishing tax regulations in a merchant profile and managing taxes, according to an exemplary embodiment of the present invention. At step 905, the merchant 130 is provided access to the validation authority 120 so that taxation information can be provided. Thus, at step 910, the merchant 130 can add taxation information to the profile. This taxation information may include, but is not limited to, the corresponding tax numbers and account information provided to a merchant 130 by the applicable taxation authority so that sales tax or any other applicable taxes can be calculated for the merchant 130. For example, if the merchant 130 is Canadian, the merchant 130 may supply to the validation authority 120 its unified tax number. By using this taxation information, the validation authority 120 could therefore generate for the merchant 130 any tax reports required. Further, based on the information provided by the merchant 130, the validation authority 120 could determine if any further layers of tax were applicable, such as Goods and Services Tax (“GST”). Also, because the validation authority 120 can determine where the user is located, and retains information related to the user (e.g., residency), then the validation authority 120 can determine what other taxes are required based on the particular user making the purchase (e.g., any additional GST tax calculations for Canadian residents).

After tax information for the merchant 130 has been provided, tax rate codes may be added to the profile in step 915. The tax rate codes may be researched and added by the validation authority 120. For example, the taxation of a merchant 130 may differ based on the taxation information provided by the merchant 130, as well as the merchant's jurisdiction. Thus, the validation authority 120 may assess the tax codes for the relevant government entity for the jurisdiction and type of merchant 130, thereby properly managing the tax calculations for the merchant 130.

With the tax codes added to the profile, the validation authority 120 can now manage the taxes for the merchant 130. Accordingly, as illustrated in step 920, the validation authority 120 may deliver a total price of goods or services, with taxes calculated, back to a point-of-sale terminal or smartcard reader 110. At step 925, the tax amount may be appended to the purchase amount. For example, as illustrated in step 930, the tax for the goods may be calculated based on the tax codes for the location of the merchant 130. Depending on where the merchant 130 is located, the validation authority 120 will therefore be able to assess the applicable tax for the merchant 130. Following this, at step 935, the point-of-sale terminal or card reader may pass tax codes to the validation authority 120 to verify that the proper tax has been calculated.

From this point, the payment transaction may continue to step 940, where the merchant 130 receives account information for the user and processes the purchase, thereby concluding the checkout. However, because the validation authority 120 plays a part in this process, it may remit the taxes from the merchant 130 to cover the taxes that are required for the purchase at step 945. Accordingly, at step 950, the validation authority 120 may send the applicable taxes to the taxation authorities on a daily basis. That is, the validation authority 120 may have communication established with the various taxation authorities to process payments on behalf of each merchant 130 using the present invention. In this way, the merchant 130 is able to mitigate the time and cost of collecting and distributing taxes to the proper governmental entities.

While the present invention and method has been described in exemplary embodiments, alternative embodiments will become apparent to one of ordinary skill in the art to which the present invention pertains without departing from the spirit and scope of the invention herein. For example, other uses for the present invention may include, but are not limited to, user to user fund transfers. In this alternative embodiment, one user could communicate through the client side application to initiate a transfer of funds through another client-side application utilized by a user. In this event, a user logging into the client side application would be able to deposit funds received from another user into a linked account of their choice. The system could also link to mobile devices such that a program could be loaded into the mobile device allowing the identification of the mobile device to be linked as an account. This would allow the user to initiate transfers via their mobile device regardless of the mobile system they are registered on.

Therefore, although this invention has been described in exemplary forms with a certain degree of particularity, it should be understood that the present disclosure has been made only by way of example, and that numerous changes and details of construction, as well as the combination and arrangement of parts or steps, may be resorted to without departing from the spirit of scope of the invention. Accordingly, the scope of the present invention is defined by the appended claims rather than the foregoing description.

We claim:

1. A method of verifying the age of a user purchasing goods or services from a merchant, the method comprising:
obtaining stored information from a smartcard associated with the user, the stored information comprising an age token identifying the validated age of the user;
sending the stored information obtained from the smartcard from a client-side application to a merchant application;
receiving at the merchant a confirmation from a validation authority verifying the authenticity of the age token received from the client-side application.

2. The method of claim 1, wherein the validation authority provides the user with the smartcard.

3. The method of claim 1, wherein the validation authority provides the user the client-side application for validating the age of the user.

4. The method of claim 1, wherein the client-side application and merchant application prompt the user for a personal identification number (“PIN”) to complete the purchase of goods or services from the merchant.

5. The method of claim 1, further comprising the steps of:
assigning by the validation authority an IPV6 to the client-side application; and
sending the assigned IPV6 from the validation authority to the merchant application to allow the merchant to verify the stored information received from the client-side application.

6. The method of claim 5, wherein the merchant application queries the smartcard using the IPV6 received from the validation authority.

7. The method of claim 5, wherein the merchant application is operative to:
determine an Internet Protocol Address of the computing device used by the user;
query the client-side application to receive a confirmation of the Internet Protocol Address; and
compare the determined and queried Internet Protocol Address to confirm the authenticity of the smartcard.

8. A system for authenticating the age of a consumer using a smartcard, the system comprising:
a validation authority for issuing the smartcard;
a client-side application to initiate age authentication using a computing device;
a merchant application for receiving and sending information to a validation authority and the client-side application to authenticate the age of the consumer; and
wherein the validation authority is operative to send a certificate verifying the age of the consumer to the merchant application.

9. The system of claim 8, wherein the validation authority is operative to calculate taxes for a payment transaction between the consumer and a merchant.

10. The system of claim 9, wherein the validation authority stores a profile for the merchant comprising taxation information related to the merchant.

11. The system of claim 9, wherein the validation authority is further operative to deduct taxes from the merchant based on the calculation of taxes for the payment transaction.

12. The system of claim 8, wherein the validation authority is further operative to:
determine whether the consumer has sufficient funds to perform a payment transaction initiated by the consumer; and
if the user has sufficient funds, supplying information regarding an account owned by the consumer to the merchant for processing the payment transaction.

13. A method for validating the identity of a consumer by a merchant, the method comprising:
detecting an Internet address associated with a computing device;
receiving a personal identification number (“PIN”) from the consumer to process a payment transaction;
querying a validation authority for information related to the consumer, wherein the information comprises a certificate validating the identity of the user stored on a smartcard;
querying a client-side application to confirm the validity of the Internet address associated with the computing device; and
if the Internet address matches, accepting the validated identity of the consumer received from the validation authority.

14. The method of claim 12, further comprising the steps of:
receiving an IPV6 assigned to the smartcard; and
querying the smartcard with the IPV6 to ensure the accuracy of the identity received from the validation authority.

15. A method for performing a payment transaction using a validation authority, the method comprising:
in response to receiving a request from a client-side application, confirming the positioning and validation of a smartcard;
in response to receiving a request from a merchant application, sending to the merchant application information related to the smartcard, wherein the information comprises a certificate confirming the user's identity;
receiving from the merchant application an amount of the payment transaction to be processed at a merchant;
sending the client-side application a list of one or more payment accounts stored at the validation authority;
receiving from the client-side application a selection of the payment account for processing the payment transaction;
passing information related to the selected payment account to the merchant application to allow the merchant to complete the payment transaction.

16. The method of claim 15, further comprising the step of checking the selected payment account to verify it has funds sufficient to cover the amount of the payment transaction.

17. The method of claim 15, further comprising the step of calculating and sending the taxes applicable to the payment transaction to the client-side application.

18. The method of claim 16, wherein the taxes calculated for the payment transaction are determined based on a merchant profile.

19. The method of claim 15, further comprising the steps of:
assigning an IPV6 to the client-side application; and
providing the IPV6 to the merchant to verify the authenticity of the client-side application.

20. The method of claim 15, further comprising the steps of:
checking the physical identity of the user at the validation authority; and
providing the user the smartcard.
